(19) United States
(12) Patent Application Publication
(10) Pub. No.: US 2009/0132274 A1
(43) Pub. Date: May 21, 2009

(54) Systems and Methods for Image and Report Preview in a Healthcare Worklist

(75) Inventors: Prakash Mahesh, Hoffman Estates, IL (US); Murali Kariathungal, Hoffman Estates, IL (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/940,649

(22) Filed: Nov. 15, 2007

(51) Int. Cl. G06Q 10/00; G06Q 50/00

(52) U.S. Cl. 705/2; 705/1

(57) ABSTRACT

Certain embodiments of the present invention provide a healthcare worklist including a user interface adapted to display a worklist entry to a user. The user interface is further adapted to display a preview of the contents of the worklist entry to the user.

### BACKGROUND OF THE INVENTION

The present invention generally relates to healthcare worklists. In particular, the present invention relates to systems and methods for image and report preview in a healthcare worklist.

Healthcare environments, such as hospitals or clinics, include information management systems such as healthcare information systems (HIS), radiology information systems (RIS), clinical information systems (CIS), cardiovascular information systems (CVIS), picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided at a plurality of locations.

Healthcare practitioners may desire to access patient information or other information at various points in a healthcare workflow. For example, during surgery, medical personnel may access patient information, such as images of a patient's anatomy, which are stored in an information management system. Alternatively, medical personnel may enter new information, such as history, diagnostic, or treatment information, into an information management system when examining a patient in a hospital.

One example of an information management system is a PACS. PACS connect to medical diagnostic imaging devices and employ an acquisition gateway (between the acquisition device and the PACS), storage and archiving units, display workstations, databases, and sophisticated data processors. These components are integrated together by a communication network and data management system. A PACS has, in general, the overall goals of streamlining health-care operations, facilitating distributed remote examination and diagnosis, and improving patient care.

A typical application of a PACS system is to provide one or more medical images for examination by a medical professional. For example, a PACS system can provide a series of x-ray images to a display workstation where the images are displayed for a radiologist to perform a diagnostic examination. Based on the presentation of these images, the radiologist can provide a diagnosis. For example, the radiologist can diagnose a tumor or lesion in x-ray images of a patient's lungs.

A reading, such as a radiology or cardiology procedure reading, is a process of a healthcare practitioner, such as a radiologist or a cardiologist, viewing digital images of a patient. The practitioner performs a diagnosis based on the content of the diagnostic images and reports on results electronically (e.g., using dictation or otherwise) or on paper. These results may then be stored in an information management system. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools.

Currently, healthcare personnel utilize worklists to organize and prioritize their workflow. Worklists show a list of exams or procedures, for example. A worklist may provide a list of exams for a radiologist to read, for example. As another example, a worklist may provide a clinician with available exam results for a particular patient for the clinician to review. Worklists may show new exams or procedures as new cases are created in the system. The worklist may allow the radiologist to organize the exams to be read based on time received or patient name, for example.

In current systems, a user must select and open an entry in their worklist to view the contents of the worklist entry. That is, worklist items must be launched in full mode to view images, reports, or other information. Each access of a worklist entry may take many seconds or minutes to view. This delay is due to the time to retrieve and process the data to be displayed. Thus, it takes many steps and minutes for a user to simply identify what kinds of images and/or reports are included in a worklist entry.

### BRIEF SUMMARY OF THE INVENTION

Certain embodiments of the present invention provide a healthcare worklist including a user interface adapted to display a worklist entry to a user. The user interface is further adapted to display a preview of the contents of the worklist entry to the user.

Certain embodiments of the present invention provide a method for displaying a worklist including receiving a worklist entry at a worklist, displaying the worklist entry to a user of the worklist, generating a preview of the contents of the worklist entry, and displaying the preview to the user.

Certain embodiments of the present invention provide a computer-readable medium including a set of instructions for execution on a computer, the set of instructions including a user interface routine configured to display a worklist entry to a user. The user interface routine is further configured to display a preview of the contents of the worklist entry to the user.

### BRIEF DESCRIPTION OF SEVERAL VIEWS OF THE DRAWINGS

FIG. 1 illustrates a system for worklist previewing according to an embodiment of the present invention.

FIG. 2 illustrates a user interface for a worklist according to an embodiment of the present invention.

FIG. 3 illustrates a user interface for a worklist according to an embodiment of the present invention.

FIG. 4 illustrates a user interface for a worklist according to an embodiment of the present invention.

FIG. 5 illustrates a user interface for a worklist according to an embodiment of the present invention.

FIG. 6 illustrates a set of images for a preview according to an embodiment of the present invention.

FIG. 7 illustrates a flow diagram for a method for displaying a worklist according to an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments of the present invention provide image and report preview in a healthcare worklist. Certain embodiments allow a user, such as a radiologist, a cardiologist, a clinician, a referring physician, or a technologist, to avoid delay and/or extra steps in determining the contents of a worklist entry. That is, certain embodiments save healthcare providers time by giving quick access to the contents of a worklist entry.

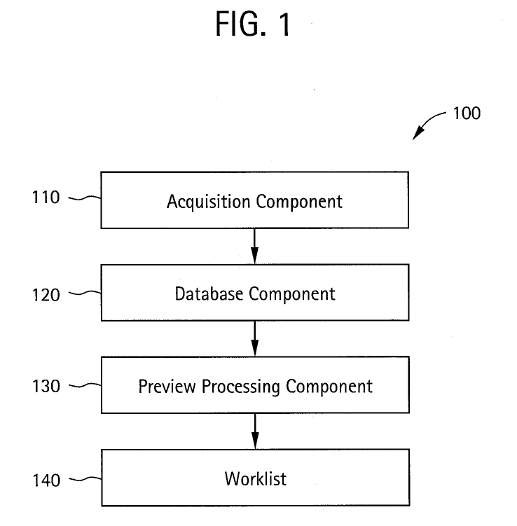

FIG. 1 illustrates a system 100 for worklist previewing according to an embodiment of the present invention. The system 100 includes an acquisition component 110, a database component 120, a preview processing component 130, and a worklist 140.

The acquisition component 110 is in communication with the database component 120. The preview processing component 130 is in communication with the database component 120 and the worklist 140.

In operation, the acquisition component 110 is adapted to generate one or more medical images. The acquisition component 110 provides the generated medical images to the database component 120. The database component 120 stores the medical images. The database component 120 may also store one or more reports related to the medical images. The preview processing component 130 processes one or more of the medical images and/or reports from the database component 120 to generate previews of the images and/or reports. The worklist 140 receives worklist entries and previews corresponding to the worklist entries. The worklist 140 displays the worklist entries to a user, such as a healthcare provider. In addition, the worklist 140 displays the previews to the user based on a trigger, such as selection of a worklist entry.

The acquisition component 110 may be, for example, an imaging system such as a computed tomography (CT) scanner and/or an magnetic resonance (MR) scanner. As another example, the acquisition component 110 may generate a medical image from a three-dimensional volumetric data set. As another example, the acquisition component 110 may provide a set of generated image slices.

The database component 120 is adapted to store medical images. The medical images may be received from the acquisition component 110, for example. The database component 120 may be part of an information management system such as a PACS or RIS, for example.

In certain embodiments, the database component 120 is adapted to store reports associated with one or more medical images. For example, a radiologist may generate a report based on a reading of a set of medical images in the database component 120. The report may then be stored in the database component 120. The report may be associated with the images read by the radiologist, for example. As another example, a report may be generated by an oncologist, cardiologist, or other healthcare provider.

The database component 120 is adapted to provide worklist entries to the worklist 140. The worklist entries may include one or more images and/or reports, for example.

The preview processing component 130 is adapted to generate a preview. The preview may be for the contents of a worklist entry, for example. A worklist entry may correspond to a particular exam, procedure, and/or study, for example. The worklist entry may include one or more images and/or reports for a healthcare provider to review, for example. For example, the preview processing component 130 may generate a preview for an image and/or report in a worklist entry to be displayed to a user by the worklist 140.

The preview may be, for example, a lower fidelity and/or quality image representing an image in the worklist entry. For example, the preview may be a thumbnail image. The thumbnail may be 40×40 pixels or 128×128 pixels, for example. As another example, while the color depth of the medical image in a worklist entry may be 32-bits per pixel, the color depth of the preview image may only be 8-bits per pixel. The preview may be in color, grayscale, or black-and-white, for example. In certain embodiments, the preview images are larger than standard thumbnails so that users can actually see what is in the images. In certain embodiments, the size and/or color depth of a preview image is specified by a user. For example, the size and/or color depth of a preview image may be based on a user preference. As another example, a user may set a smallest and/or largest size for a preview image. In certain embodiments, the preview includes a small control to display a thumbnail-like viewer to show the preview images and preview reports.

In certain embodiments, the preview for an image in the worklist entry is based on the modality type. For example, for a multi-frame MR exam, the preview may be of the cine of the multi-frame MR. As another example, a set of CT images in a worklist may have a preview generated that includes a stack of thumbnail images that a user can scroll through. As another example, a preview including multiple images may display the multiple images at the same time. As another example, for a preview of a worklist entry including a medical image, the preview image may be the first image in a set of images in the worklist entry or key images from the set of images.

The preview may allow a user to identify the kinds of images included in a worklist entry without having to open the worklist entry, for example. For example, a clinician may be able to identify that a worklist entry includes CT images of the spine of a patient, for example, based on the preview image and realize that the worklist entry is for a different exam than the one the clinician is looking for without having to open the worklist entry. As another example, a preview may include a CT of a lung showing lung nodules using 3D techniques.

In certain embodiments, the preview may be, for example, a summary of a report included in the worklist entry. For example, the preview of the report may include key impressions and/or positives/negatives. As another example, the preview of the report may be text that states that the results were normal and may identify one or more findings by the radiologist that read the report. Thus, a user may be able to determine the report's prognosis without having to open each worklist entry.

In certain embodiments, the preview may be generated based on user preferences. A user preference may indicate that a user prefers to see just images, just reports, or both images and reports in a worklist entry preview, for example. A user preference may indicate how preview images should be presented in a generated preview. For example, a user preference may be set indicating that a user prefers to see the first image in a series of images (e.g., such as a series of generated image slices) in as a preview image. As another example, a user preference may indicate that a user prefers to see key images from a series of images in the preview. As another example, a user preference may indicate that a user prefers to see the middle image from a set of images. A user preference may indicate how preview reports should be presented in a generated preview. For example, a user preference may indicate that a user prefers to see just a diagnosis in a preview report. As another example, a user preference may indicate that a user prefers to see both a diagnosis and key findings in a preview report.

In certain embodiments, the preview processing component 130 is part of the database component 120. For example, the database component 120 and the preview processing component 130 may be part of a PACS server. Thus, the preview processing component 130 may run on the same computing system as the database component 120. In certain embodiments, the preview processing component 130 pre-computes a preview for a worklist entry. For example, the preview may be pre-computed when an image and/or report is received in the database component 120. The image may be received from an acquisition component similar to the acquisition component 110, described above, for example. As another example, the preview may be pre-computed when a worklist entry is generated. In certain embodiments, the preview processing component 130 streams a preview to a worklist 140 for display. For example, a preview may include a series of images. The preview image for each image in the series in the preview may be streamed to a worklist 140 for display, for example.

In certain embodiments, the preview processing component 130 is part of the worklist 140. For example, the preview processing component 130 and the worklist 140 may be part of a PACS workstation. Thus, the preview processing component 130 may run on the same computing system as the worklist 140. In certain embodiments, the preview processing component 130 pre-computes a preview for a worklist entry. For example, the preview may be pre-computed when a worklist entry is received at a worklist 140. In certain embodiments, the preview processing component 130 generates the preview on-the-fly, when the preview is to be displayed.

The worklist 140 is adapted to display one or more worklist entries. The worklist 140 allows a user to view, organize, and/or process worklist entries. The worklist 140 may be used by a technologist, lab technician, radiologist, referring physician, or cardiologist, for example. For example, a radiologist may use the worklist 140 to determine in what order to read a particular exam and/or study. As another example, a physician may utilize the worklist 140 to view exams and reports prepared for a particular patient.

The worklist 140 may retrieve one or more medical images and/or reports from the database component 120. The worklist 140 may retrieve the medical images and/or reports in response to a user's request, for example. As another example, the worklist 140 may retrieve the medical images and/or reports automatically, to progress through worklist entries. The worklist 140 may display the retrieved medical image to a user, for example.

In certain embodiments, the preview is displayed by the worklist 140 based on a trigger. The trigger may be, for example, the selection of a worklist entry by a user. As another example, the trigger may be a user placing a mouse or other pointer over the worklist entry. In certain embodiments, the trigger to be used to determine when a preview should be displayed is controlled by a user preference.

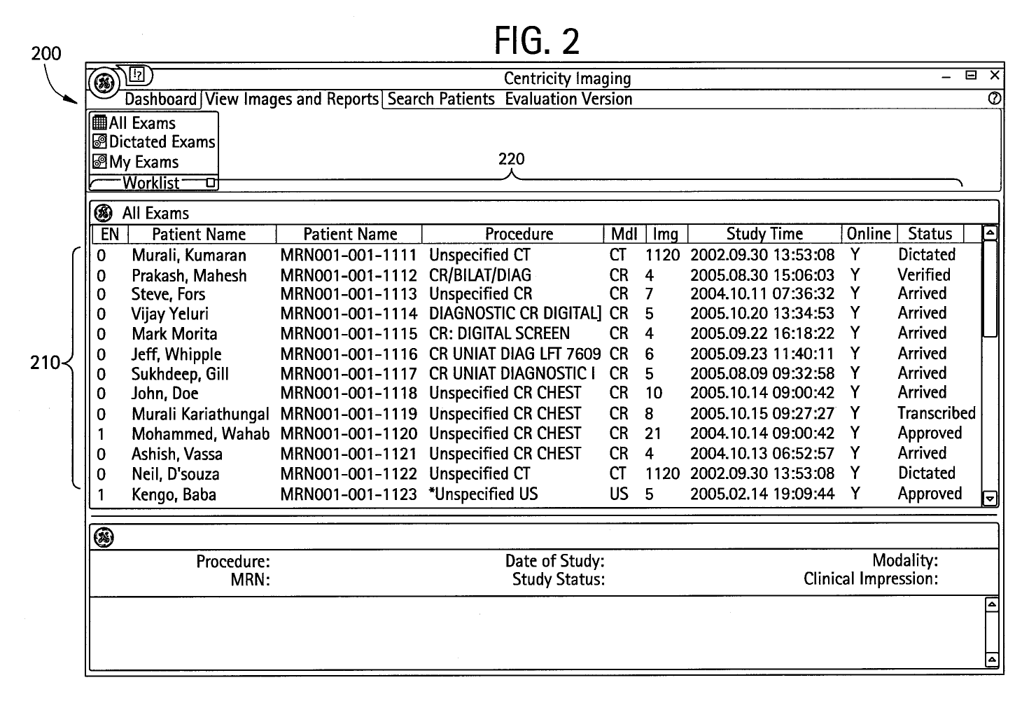

FIG. 2 illustrates a user interface 200 for a worklist according to an embodiment of the present invention. The user interface 200 includes rows for each entry 210 in the worklist. The user interface includes columns 220 that separate fields in each worklist entry 210. The worklist may be similar to the worklist 140, described above, for example.

In operation, a user may use the user interface 200 for the worklist to view, organize, and/or process worklist entries 210. That is, the user interface 200 is adapted to display worklist entries to a user. A user may be a physician, radiologist, referring physician, technician, or other healthcare provider, for example. A worklist entry 210 may correspond to a particular patient, procedure, study, report, and/or set of images, for example. For example, a radiologist may utilize the user interface 200 of the worklist to view the sets of images, as indicated by each worklist entry 110 in the worklist, he has to read. Opening a worklist entry 210 may bring up one or more images and/or reports associated with the entry, for example. For example, a radiologist may open a worklist entry 210 to read a set of CT image slices associated with that entry.

The columns 220 in the user interface 200 correspond to fields in each worklist entry 210. Columns 220 may correspond to fields such as, for example, patient name, patient identifier, procedure, modality, number of images, study time, online availability, and status.

The user interface 200 may provide various mechanisms to organize worklist entries 210. For example, a user may select a button in the user interface 200 to display entries for recent exams in the worklist. As another example, a user may select a button in the user interface 200 to display entries for unread exams in the worklist. As another example, the user interface 200 may be sorted using the worklist columns 220. For example, a radiologist may utilize the user interface 200 to sort worklist entries 210 by patient name by selecting the “patient name” column 220 to locate an entry 210 for a particular patient to see the corresponding procedure information.

The user interface 200 is adapted to display a preview to the user. The preview may be similar to the preview generated by the preview processing component 130, described above, for example. The preview may be for a worklist entry displayed by the user interface 200, for example.

In certain embodiments, the preview is displayed by the user interface 200 based on a trigger. The trigger may be, for example, the selection of a worklist entry by a user. As another example, the trigger may be a user placing a mouse or other pointer over the worklist entry. In certain embodiments, the trigger to be used to determine when a preview should be displayed is controlled by a user preference.

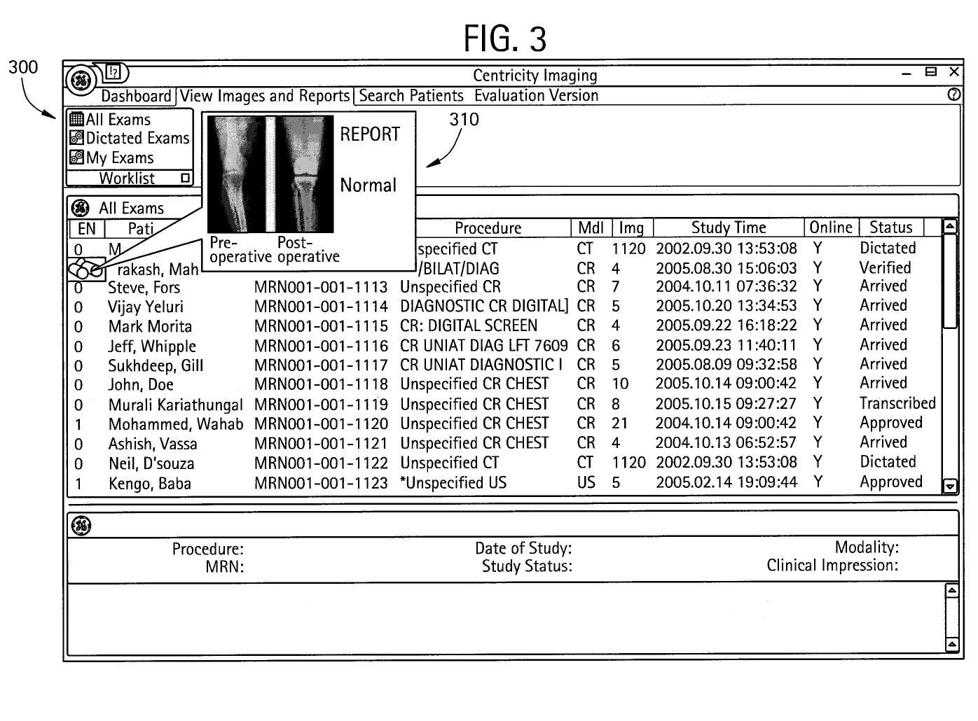

FIGS. 3-6, described in more detail below, illustrate various previews displayed by a user interface similar to the user interface 200 according to embodiments of the present invention.

FIG. 3 illustrates a user interface 300 for a worklist according to an embodiment of the present invention. More particularly, the user interface 300 is illustrated showing a preview 310 for a worklist entry. The user interface 300 may be similar to the user interface 200, described above, for example.

The preview 310 includes two preview images and a preview report. The preview images in the preview 310 may be thumbnails of two images in the worklist entry, for example. The preview report may be a summary of the diagnosis from a radiologist's report in the worklist entry, for example.

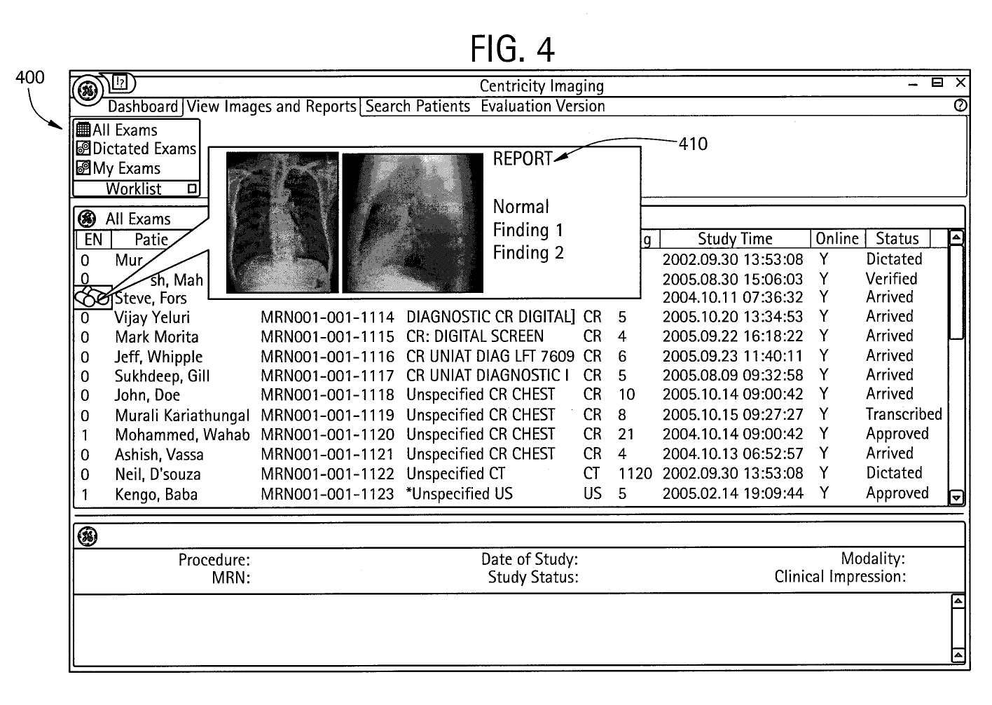

FIG. 4 illustrates a user interface 400 for a worklist according to an embodiment of the present invention. More particularly, the user interface 400 is illustrated showing a preview 410 for a worklist entry. The user interface 400 may be similar to the user interface 200, described above, for example.

The preview 410 includes two preview images and a preview report. The preview images in the preview 410 may be key images from a set of images in the worklist entry, for example. The preview report may be a summary of the diagnosis from a radiologist's report in the worklist entry, including findings, for example. For example, the preview report may indicate the diagnosis along with key findings made by the radiologist when reading the exam.

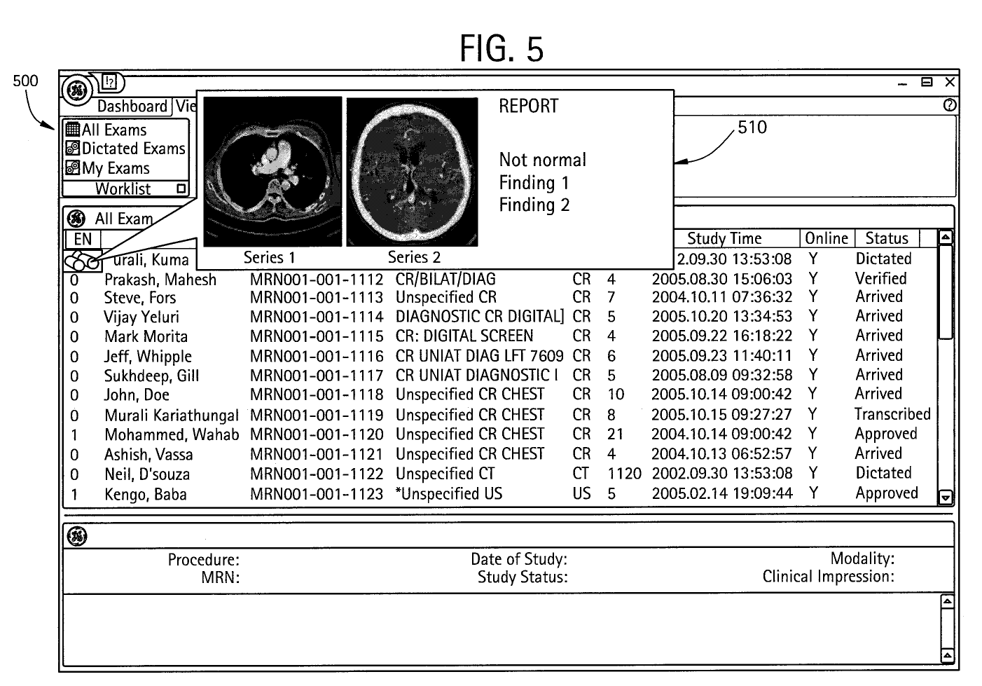

FIG. 5 illustrates a user interface 500 for a worklist according to an embodiment of the present invention. More particularly, the user interface 500 is illustrated showing a preview 510 for a worklist entry. The user interface 500 may be similar to the user interface 200, described above, for example.

The preview 510 includes two preview image series and a preview report. The preview image series in the preview 510 may each be sets of images representing key images from two corresponding series of images (e.g., generated image slices from a three-dimensional volumetric data set) in the worklist entry, for example. As discussed above, the user interface 500 may allow a user to scroll through each image in each set of preview images, for example. The preview report may be a summary of the diagnosis from a radiologist's report in the worklist entry, including findings, for example. For example, the preview report may indicate the diagnosis along with key findings made by the radiologist when reading the image series.

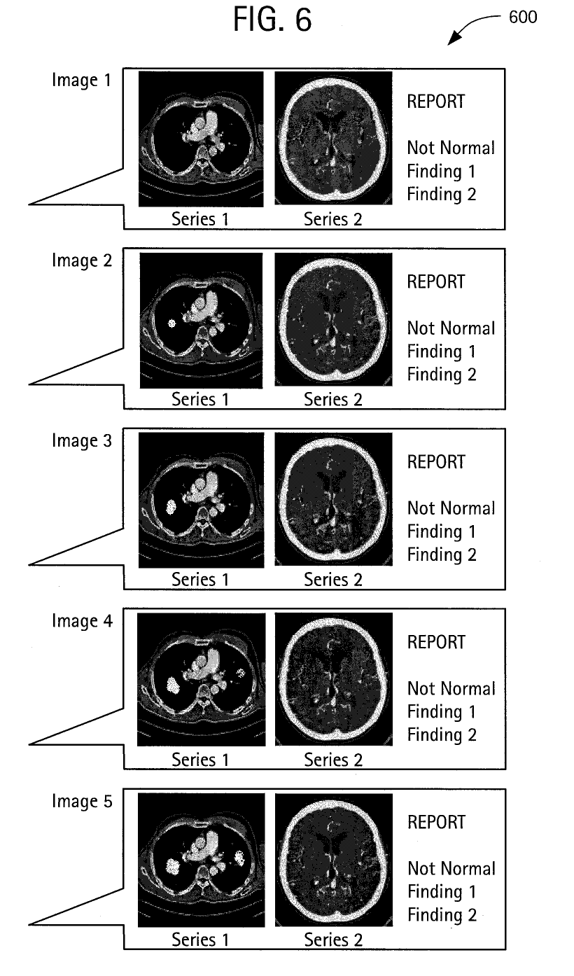

FIG. 6 illustrates a set of images 600 for a preview according to an embodiment of the present invention. More particularly, FIG. 6 illustrates the display of a preview for the worklist entry illustrated in FIG. 5, discussed above, as a user scrolls through a set of images 600 for “Series 1” in the preview. Notice that in each illustrated display of the preview in the sequence, the image for “Series 1” changes as the user scrolls through the five images in set of images 600.

The components, elements, and/or functionality of the interface(s) and system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device, such as, for example, a PACS workstation or one or more dedicated processors.

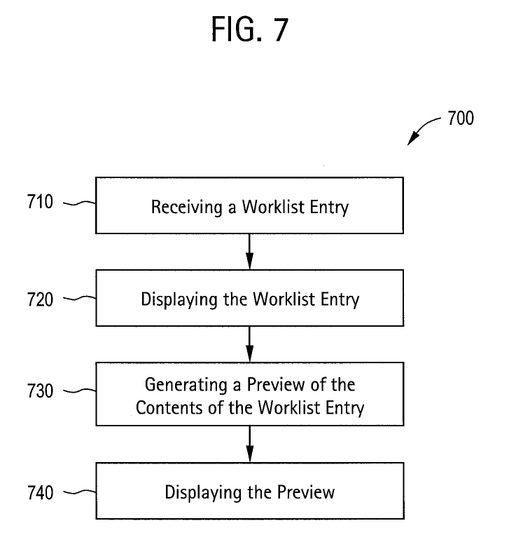

FIG. 7 illustrates a flow diagram 700 for a method for displaying a worklist according to an embodiment of the present invention. The method includes the following steps, which will be described below in more detail. At step 710, a worklist entry is received. At step 720, the worklist entry is displayed. At step 730, a preview of the contents of the worklist entry is generated. At step 740, the preview is displayed. The method is described with reference to elements of systems described above, but it should be understood that other implementations are possible.

At step 710, a worklist entry is received. The worklist entry may be similar to the worklist entries described above, for example. The worklist entry may correspond to a particular exam, procedure, and/or study, for example. The worklist entry may include one or more images and/or reports for a healthcare provider to review, for example.

The worklist entry may be received from a database component similar to the database component 120, described above, for example. The worklist entry may be received at a worklist similar to the worklist 140, described above, for example.

For example, the worklist 140 may retrieve one or more medical images and/or reports from the database component 120. The worklist 140 may retrieve the medical images and/or reports in response to a user's request, for example. As another example, the worklist 140 may retrieve the medical images and/or reports automatically, to progress through worklist entries.

At step 720, the worklist entry is displayed. The worklist entry may be the worklist entry received at step 710, described above, for example. The worklist entry may be displayed by a worklist similar to the worklist 140, described above. For example, the worklist 140 may allow a user to view, organize, and/or process worklist entries. The worklist entry may be displayed to a technologist, lab technician, radiologist, referring physician, or cardiologist, for example. The preview may be displayed by a user interface for a worklist similar to the user interfaces 200, 300, 400, and/or 500, described above, for example.

At step 730, a preview of the contents of the worklist entry is generated. The worklist entry may be the worklist entry received at step 710, described above, for example. The worklist entry may be the worklist entry displayed at step 720, described above, for example.

The preview may be generated by a preview processing component similar to the preview processing component 130, described above, for example. The preview may be for the contents of a worklist entry, for example. A worklist entry may correspond to a particular exam, procedure, and/or study, for example. The worklist entry may include one or more images and/or reports for a healthcare provider to review, for example. For example, the preview processing component 130 may generate a preview for an image and/or report in a worklist entry to be displayed to a user by the worklist 140.

The preview may be, for example, a lower fidelity and/or quality image representing an image in the worklist entry. For example, the preview may be a thumbnail image. The thumbnail may be 40×40 pixels or 128×128 pixels, for example. As another example, while the color depth of the medical image in a worklist entry may be 32-bits per pixel, the color depth of the preview image may only be 8-bits per pixel. The preview may be in color, grayscale, or black-and-white, for example. In certain embodiments, the preview images are larger than standard thumbnails so that users can actually see what is in the images. In certain embodiments, the size and/or color depth of a preview image is specified by a user. For example, the size and/or color depth of a preview image may be based on a user preference. As another example, a user may set a smallest and/or largest size for a preview image. In certain embodiments, the preview includes a small control to display a thumbnail-like viewer to show the preview images and preview reports. In certain embodiments, the preview for an image in the worklist entry is based on the modality type.

The preview may allow a user to identify the kinds of images included in a worklist entry without having to open the worklist entry, for example. For example, a clinician may be able to identify that a worklist entry includes CT images of the spine of a patient, for example, based on the preview image and realize that the worklist entry is for a different exam than the one the clinician is looking for without having to open the worklist entry.

In certain embodiments, the preview may be, for example, a summary of a report included in the worklist entry. For example, the preview of the report may include key impressions and/or positives/negatives. As another example, the preview of the report may be text that states that the results were normal and may identify one or more findings by the radiologist that read the report. Thus, a user may be able to determine the report's prognosis without having to open each worklist entry.

In certain embodiments, the preview may be generated based on user preferences. A user preference may indicate that a user prefers to see just images, just reports, or both images and reports in a worklist entry preview, for example. A user preference may indicate how preview images should be presented in a generated preview. For example, a user preference may be set indicating that a user prefers to see the first image in a series of images (e.g., such as a series of generated image slices) in as a preview image. As another example, a user preference may indicate that a user prefers to see key images from a series of images in the preview. As another example, a user preference may indicate that a user prefers to see the middle image from a set of images. A user preference may indicate how preview reports should be presented in a generated preview. For example, a user preference may indicate that a user prefers to see just a diagnosis in a preview report. As another example, a user preference may indicate that a user prefers to see both a diagnosis and key findings in a preview report.

In certain embodiments, the preview is generated by a preview processing component that is part of a database component. For example, the database component 120 and the preview processing component 130 may be part of a PACS server. Thus, the preview processing component 130 may run on the same computing system as the database component 120. In certain embodiments, the preview is pre-computed. For example, the preview may be pre-computed when an image and/or report is received in the database component 120. The image may be received from an acquisition component similar to the acquisition component 110, described above, for example. As another example, the preview may be pre-computed when a worklist entry is generated. In certain embodiments, the preview is streamed to a worklist 140. For example, a preview may include a series of images. The preview image for each image in the series in the preview may be streamed to a worklist 140, for example.

In certain embodiments, the preview is generated by a preview processing component that is part of a worklist. For example, the preview processing component 130 and the worklist 140 may be part of a PACS workstation. Thus, the preview processing component 130 may run on the same computing system as the worklist 140. In certain embodiments, the preview is pre-computed. For example, the preview may be pre-computed when a worklist entry is received at a worklist 140. In certain embodiments, the preview is generated on-the-fly, when the preview is to be displayed.

In certain embodiments, the generation of the preview is performed prior to the step 710 of receiving the worklist entry, described above. Thus, the preview may be generated before the worklist entry is communicated to a worklist similar to the worklist 140, for example. In certain embodiments, the worklist entry is communicated with the preview.

At step 740, the preview is displayed. The preview may be the preview generated at step 730, described above, for example. The preview may be displayed by a worklist similar to the worklist 140, described above, for example. The preview may be displayed by a user interface for a worklist similar to the user interfaces 200, 300, 400, and/or 500, described above, for example.

The preview may be similar to the preview generated by the preview processing component 130, described above, for example. The preview may be for a worklist entry displayed by the user interface 200, for example.

In certain embodiments, the preview is displayed based on a trigger. The trigger may be, for example, the selection of a worklist entry by a user. As another example, the trigger may be a user placing a mouse or other pointer over the worklist entry. In certain embodiments, the trigger to be used to determine when a preview should be displayed is controlled by a user preference.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

One or more of the steps of the method may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention provide image and report preview in a healthcare worklist. Certain embodiments allow a user to avoid delay and/or extra steps in determining the contents of a worklist entry. Certain embodiments of the present invention provide a technical effect of image and report preview in a healthcare worklist. Certain embodiments provide a technical effect of allowing a user to avoid delay and/or extra steps in determining the contents of a worklist entry.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems, and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any healthcare information system. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A healthcare worklist comprising:
a user interface adapted to display a worklist entry to a user, wherein the user interface is further adapted to display a preview of the contents of the worklist entry to the user.

2. The worklist of claim 1, wherein the worklist entry includes at least one of a medical image and a report.

3. The worklist of claim 1, wherein the preview includes a thumbnail of an image in the worklist entry.

4. The worklist of claim 1, wherein the preview is based at least in part on a user preference.

5. The worklist of claim 1, wherein the preview is generated by a healthcare information management system and communicated to the user interface.

6. The worklist of claim 1, wherein the preview is generated when a medical image is acquired by an acquisition component.

7. The worklist of claim 1, further including a preview processing component adapted to generate the preview based at least in part on the worklist entry.

8. The worklist of claim 7, wherein the preview is communicated to the user interface with the worklist entry.

9. The worklist of claim 1, wherein the user interface is adapted to display the preview based on a trigger.

10. The worklist of claim 9, wherein the trigger includes at least one of a user selecting the worklist entry and a user moving a mouse over the displayed worklist entry.

11. The worklist of claim 9, wherein the trigger is based on a user preference.

12. The worklist of claim 1, wherein the preview includes a plurality of images, wherein the user interface is adapted to allow the user to display each image in the plurality of images.

13. A method for displaying a worklist, the method comprising:
receiving a worklist entry at a worklist;
displaying the worklist entry to a user of the worklist;
generating a preview of the contents of the worklist entry; and
displaying the preview to the user.

14. The method of claim 13, wherein the worklist entry includes at least one of a medical image and a report.

15. The method of claim 13, wherein the generating step is performed by a preview processing component.

16. The method of claim 15, wherein the preview processing component is part of a healthcare information management system.

17. The method of claim 15, wherein the preview processing component is part of the worklist.

18. The method of claim 13, wherein the preview is displayed based on a trigger.

19. The method of claim 13, wherein the generating step is performed prior to the receiving step, and wherein the receiving step further includes receiving the preview at the worklist.

20. A computer-readable medium including a set of instructions for execution on a computer, the set of instructions comprising:
a user interface routine configured to display a worklist entry to a user, wherein the user interface routine is further configured to display a preview of the contents of the worklist entry to the user.
